(19) United States
(12) Patent Application Publication
(10) Pub. No.: US 2012/0272601 A1
(43) Pub. Date: Nov. 1, 2012

(54) Frame and Panel Door

(75) Inventor: Demos Mouskis, Limassol (CY)

(73) Assignee: MUSKITA ALUMINIUM INDUSTRIES PLC, Lemesos (CY)

(21) Appl. No.: 13/096,288

(22) Filed: Apr. 28, 2011

(51) Int. Cl. E06B 3/76; B23P 11/00

(52) U.S. Cl. 52/458; 29/428; 49/381

(57) ABSTRACT

A door having a frame and panel construction, wherein the panel comprises a plurality of planks received in a rebate formed in the surrounding frame, and the planks include extruded aluminum profiles. Also, a door unit, and a method of constructing the door.

### FIELD OF THE INVENTION

The present invention generally relates to a door having a frame and panel construction, a door unit, and a method of constructing the door.

### BACKGROUND

Aluminum has a high strength to weight ratio and is commonly used in constructing door frames, particularly for domestic homes, as it provides a good level of security. A typical aluminum framed door further includes a panel comprising plastics (often PVC) material sandwiching a thermally insulating foam material. Despite the security afforded by the strength of the aluminum frame the plastics panel can be relatively easily punctured, which reduces the security of the door construction. The plastics panel is also relatively flexible, which detracts from the quality feel afforded by a solid wood door, for example.

Solid wood doors have their own disadvantages in that they can be susceptible to distortion with seasonal changes, are generally more expensive, and are more difficult to maintain and weatherproof.

There is a need for an improved door that is solid, secure, durable, thermally and acoustically insulated, has high aesthetic appeal, is easy to maintain, and which can be highly customized.

### SUMMARY OF THE DISCLOSURE

A first aspect of the invention provides a door having a frame and panel construction, wherein the panel comprises a plurality of planks received in a rebate formed in the surrounding frame, and the planks include extruded aluminum profiles.

A further aspect of the invention provides a method of assembling a door having a frame and panel construction, the method comprising assembling an incomplete frame having a rebate, assembling a panel by arranging a plurality of planks received in the rebate in the surrounding frame, and completing the frame after the panel assembly is complete, wherein the planks include extruded aluminum profiles.

The invention is advantageous in that the extruded aluminum planks received in the rebated frame provide a particularly solid, secure, durable, thermally insulated, highly customizable, low maintenance door that can be provided in a variety of aesthetic finishes and colors, including wood grain effect.

The planks preferably interlock to form the panel. The planks may interlock using a tongue and groove system. Preferably the planks interlock with an interference fit and without fasteners. Alternatively, the planks may be clipped together to form the panel.

The panel is preferably received in the rebated frame with an interference fit, and without fasteners and without exposed beading. The panel therefore contributes significantly to the structural rigidity of the door, and is highly secure as there are no exposed beads or trims that can be removed.

The planks may be oriented horizontally, vertically, or at any intermediate angle. The panel may be divided into a plurality of plank portions each containing one or more of the planks, and at least one plank portion includes planks oriented differently to at least one other plank portion. The panel may include a generally H-shaped profiled section interlocked between adjacent plank portions. The H-shaped profile provides an overlapping weatherproof connection between the edges of each section.

This provides a highly customizable modular design to create a wide variety of panel designs from only a few different plank profiles. Typically less than ten, and preferably less than five, different plank profiles of various widths are required for a complete range of doors. The extruded aluminum planks may be provided as long lengths, which can be cut to size depending on the panel design and the door dimensions.

The panel may further comprise a glass pane surrounded by the planks. The panel may include a generally H-shaped profiled section interlocked between the glass pane and the surrounding planks.

Each plank preferably includes a pair of back-to-back extruded aluminum profiles with one or more thermally insulating bridges extending between the profiles. Similarly, the H-shaped profiled section may include a pair of back-to-back extruded aluminum profiles with a thermally insulating bridge extending between the profile. The insulating bridge preferably includes polyamide material. The bridge may be dovetailed to the aluminum profiles to provide a secure connection.

The frame preferably includes extruded aluminum profiles. The frame may have a similar construction to planks and preferably includes a pair of back-to-back extruded aluminum profiles with one or more thermally insulating bridges extending between the profiles.

The frame may comprises rails and stiles. The frame may include top and bottom rails and a pair of vertical stiles to provide a rectangular frame. Each of the rails and stiles may have the same extruded aluminum profiles. The stiles and rails may be mitred at each corner. A truncated frame, for fitting under eaves for example, may include a pentagonal frame.

The planks and/or the frame may be painted or anodised. In one embodiment, the paint provides a textured wood grain effect finish. The resultant door may therefore have the appearance of a traditional solid timber door.

The door may be provided as a door unit comprising one or more doors according to the invention mounted for movement with respect to a doorway frame.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates an aluminum door having a frame and panel construction, in which the panel comprises a set of vertically aligned interlocking extruded aluminum planks;

FIG. 2 illustrates a cross section through the frame;

FIG. 3 illustrates a cross section through one of the planks;

FIG. 4 illustrates a cross section through a pair of the planks interlocked by a tongue and groove joint;

FIG. 5 illustrates a cross section through one of the planks received in the rebate of the frame;

FIGS. 6a-d illustrate various planks having common tongue and groove dimensions but different widths;

FIG. 7 illustrates an H-shaped profiled section used to join adjacent portions of the panel;

FIG. 8a illustrates the H-shaped profile used to join between two planks, and FIG. 8b used to join between a plank and a glass pane;

FIGS. 9a-zd illustrate various doors having different panel arrangements; and

FIG. 10 illustrates a door unit comprising the door of FIG. 1 installed in a doorway frame.

### DETAILED DESCRIPTION

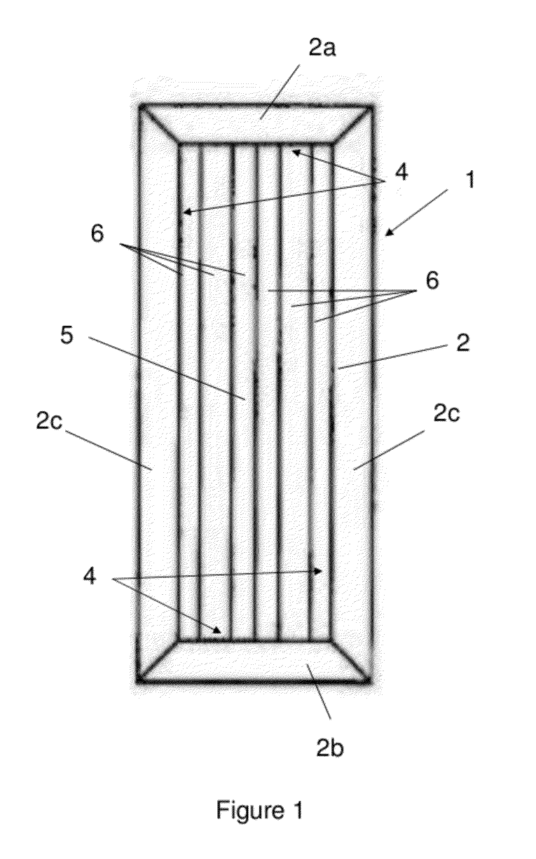

FIG. 1 illustrates a door 1 having a frame and panel construction. The door comprises a frame 2 including a top horizontal rail 2a, a bottom horizontal rail 2b, and a pair of vertical stiles 2c extending between the rails 2a, 2b. The frame 2 includes a rebated inner edge 4 which surrounds a panel 5. The rails 2a, 2b and stiles 2c have mitred corners. The panel 5 includes a plurality of vertically arranged interlocking tongue and groove planks 6.

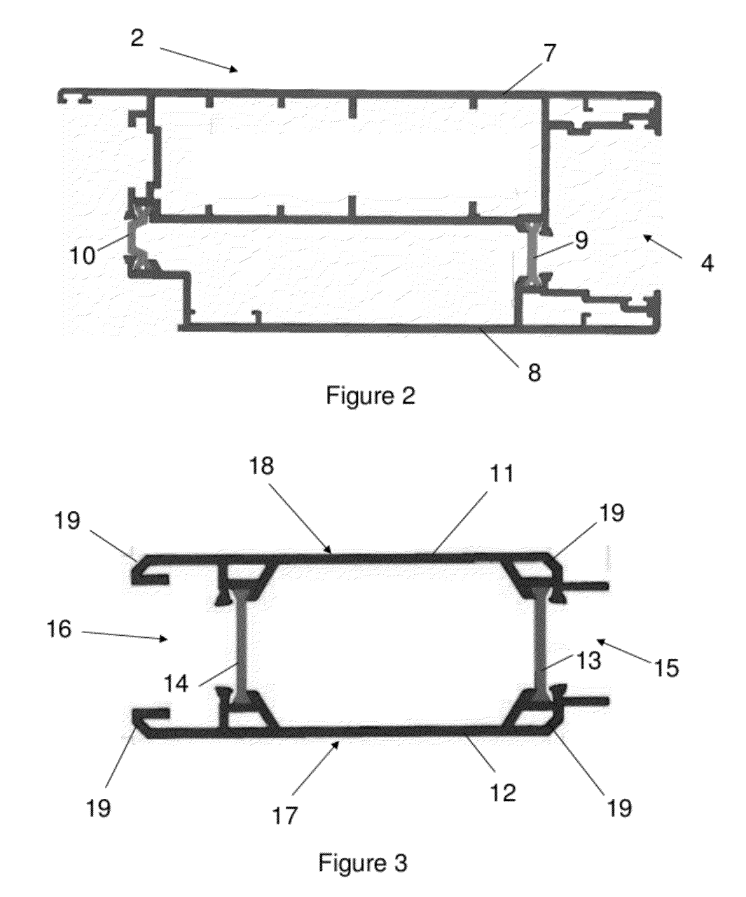

FIG. 2 illustrates a cross section through the frame 2. The frame 2 includes a pair of extruded aluminum profiles 7, 8 arranged back-to-back with a pair of thermally insulating polyamide bridge members 9, 10 extending between the profiles 7, 8. The bridge members 9, 10 are dovetailed to the profiles 7, 8. The frame rails 2a, 2b and stiles 2c each have an identical section profile, which may be provided as a continuous extrusion. The frame extrusion may be cut to any desired length depending on the width and height dimensions of the door 1. The profiles 7, 8 with the bridge members 9, 10 define the rebate 4 which receives the panel 5.

FIG. 3 illustrates a cross section through one of the planks 6. The plank 6 includes a pair of extruded aluminum profiles 11, 12 arranged back-to-back with a pair of thermally insulating polyamide bridge members 13, 14 extending between the profiles 11, 12. The bridge members 13, 14 are dovetailed to the profiles 11, 12. The plank 6 has a tongue profile 15 at one edge and a groove profile 16 at its opposite edge, such that the planks 6 can be joined side-by-side by their interlocking tongue and groove profiles 15, 16.

The plank 6 includes substantially planar opposing outer surfaces 17, 18 which form the panel surfaces on either side of the door 1. Chamfered edges 19 form V-shaped grooves in the panel surfaces in the assembled door. The completed door 1 therefore has the exterior appearance of a traditional solid wood door.

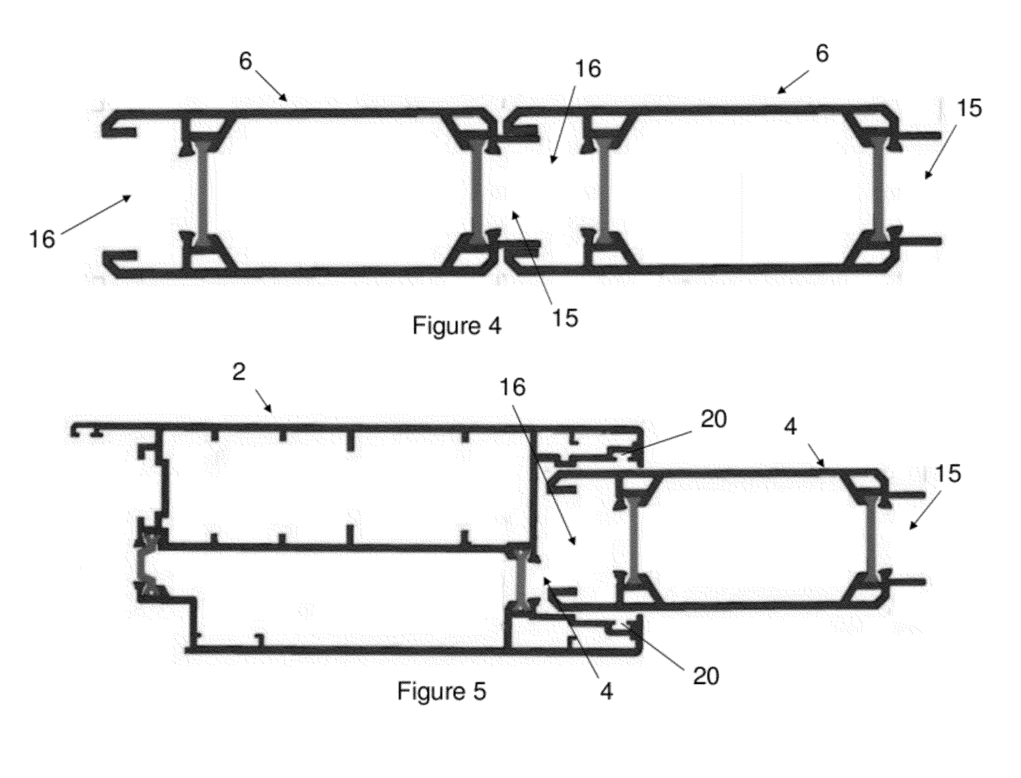

FIG. 4 illustrates a pair of the planks 6 interlocked by their respective tongue 15 and groove 16 profiles, which are dimensioned to provide an interference fit. No fixings, fasteners or beading is required to join the planks 6 together.

FIG. 5 illustrates one of the planks 6 received in the rebate 4 in the frame 2. The plank 6 and the rebate 4 are dimensioned to provide an interference fit. No fixings, fasteners or external beading is required to join the plank 6 to the rebated frame 2. However, the rebate 4 includes grooves 20 which each receive a length of beading (not shown) so as to provide a weatherproof seal. The beading is applied before the planks 6 are installed in the frame 2. Although FIG. 5 illustrates the plank 6 received in the rebated frame2 by its groove profiled edge 16, it will be appreciate that the plank 6 nearest the opposite side of the frame 2 will be received by its tongue profiled edge 15.

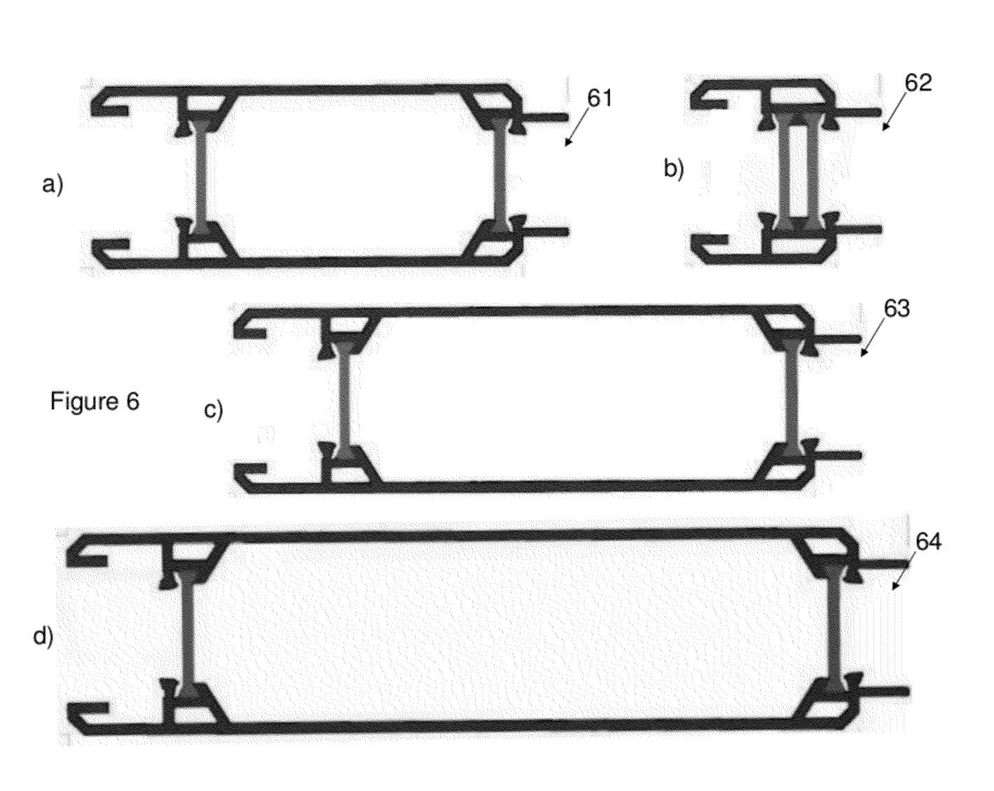

FIG. 6 illustrates an array of different planks 61, 62, 63, 64 which essentially differ from the plank 6 only in that they have a different width dimension. The tongue and groove profiles remain identical such that the planks 61, 62, 63, 64 can be interconnected with one another and all fit the common profile of the frame 2. This provides great flexibility to provide doors of different designs and dimensions. Each of the plank profiles 6, 61, 62, 63 and 64 may be provided as a continuous extrusion. The plank extrusions may be cut to any desired length depending on the dimensions of the door 1.

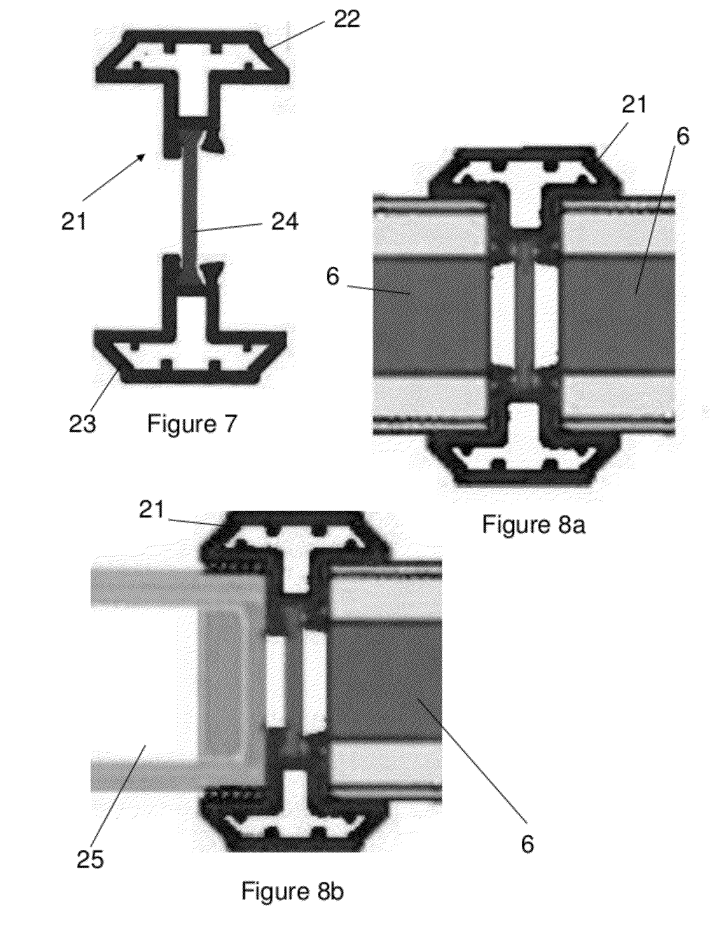

FIG. 7 illustrates a generally H-shaped profiled section 21, which comprises a pair of extruded aluminum profiles 22, 23 arranged back-to-back with a thermally insulating polyamide bridge member 24 extending between the profiles 22, 23. The bridge member 24 is dovetailed to the profiles 22, 23.

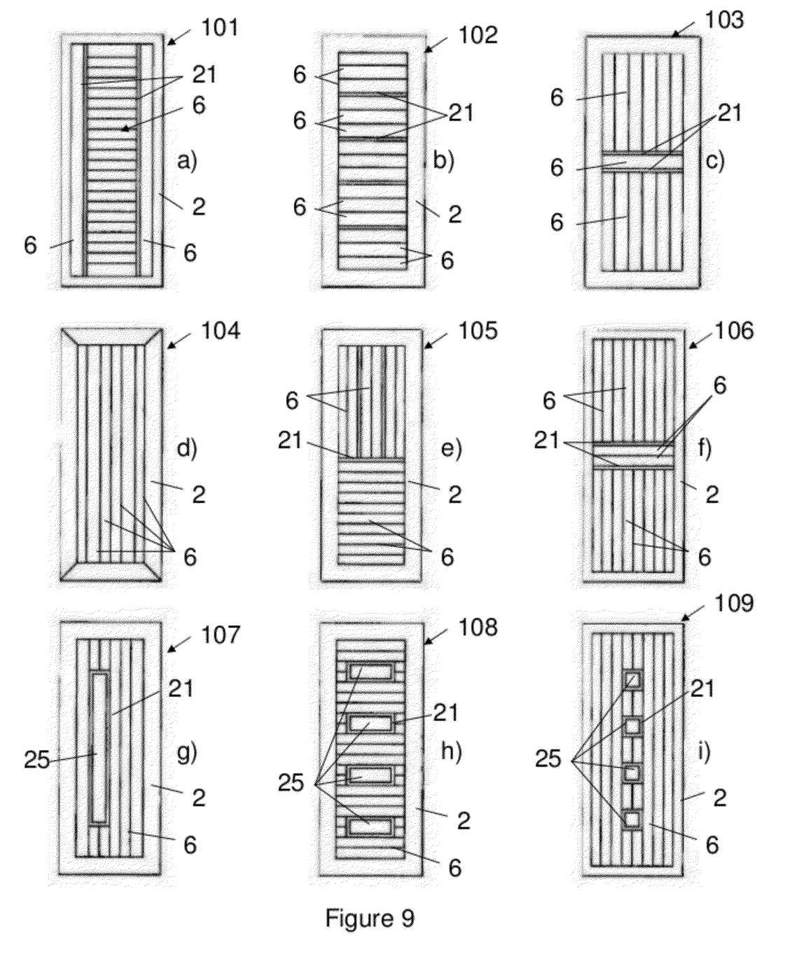

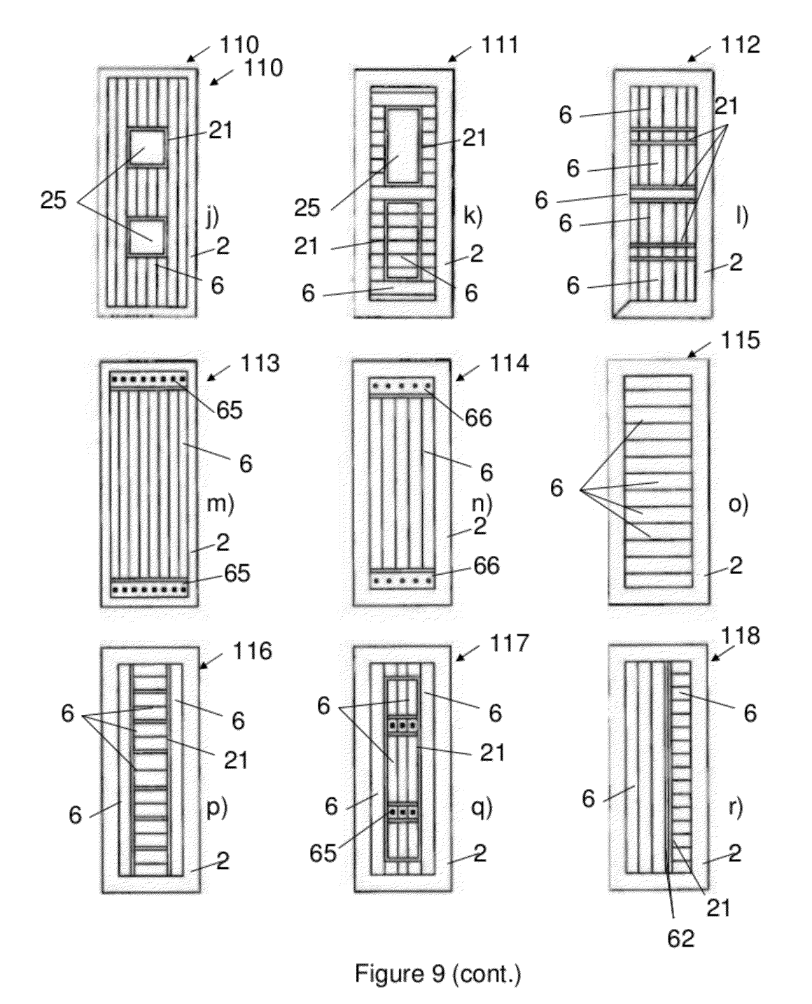

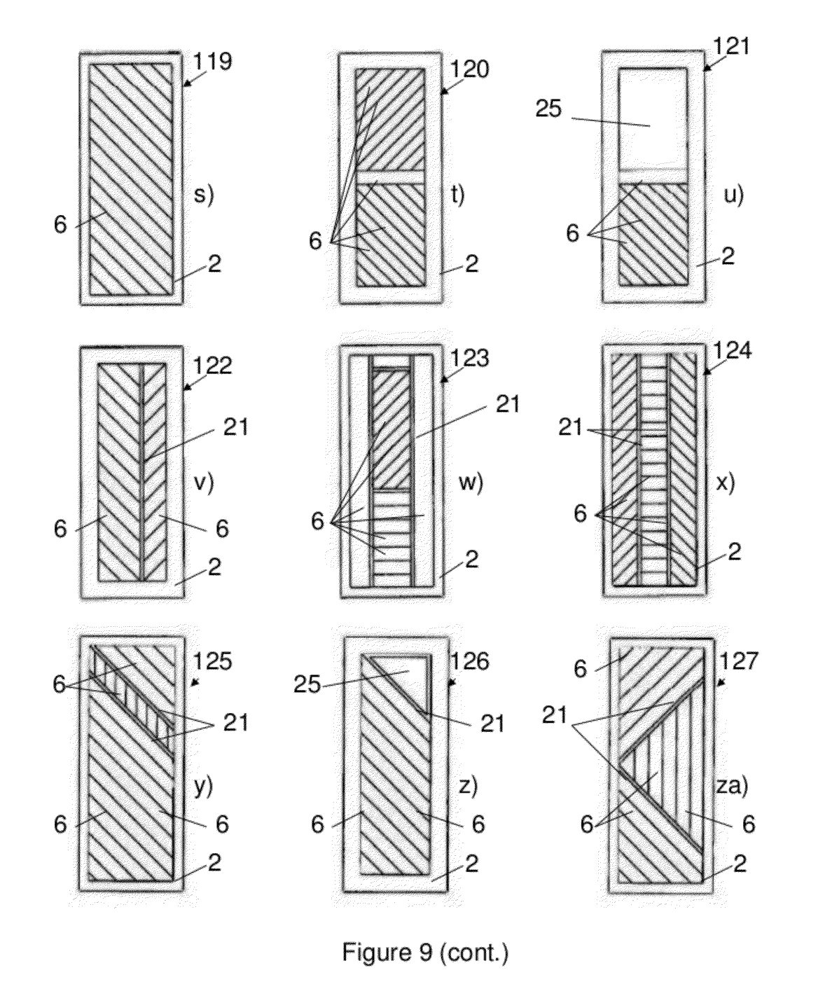

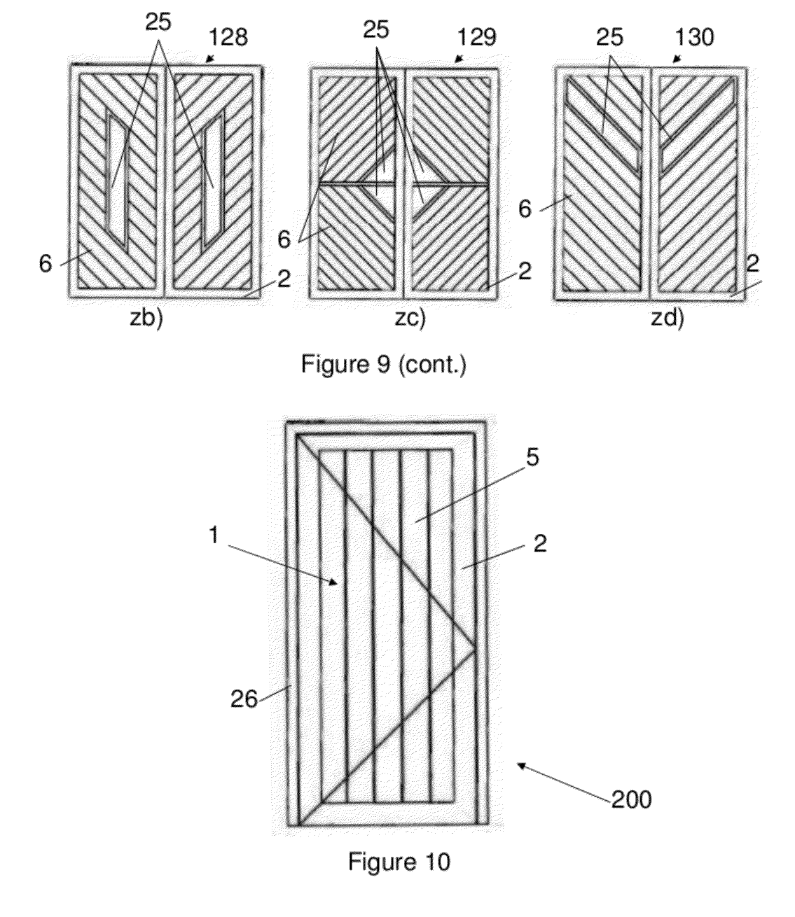

FIG. 8a illustrates the H-shaped profiled section 21 used to join between cut ends of the planks 6. FIG. 8b illustrates the H-shaped profiled section 21 used to join between cut ends of the planks 6 and the edge of a glass pane 25. The need for the H-shaped profiled section 21 in some door designs will become apparent from the description of FIGS. 9a-zd below, which illustrate a variety of doors having different panel designs.

The door 1 is assembled by cutting the extruded aluminum frame sections 2a, 2b, 2c and the planks 6 to desired lengths. Three of the frame sides are connected to form an open frame. The planks 6 are then loaded into the rebate 4 in the open frame before the frame is closed with the fourth side. The completed frame 2 fully retains the panel 5 securely without any fixings.

The planks 6 and the frame 2 may be painted or anodised prior to cutting and assembly. By applying the surface finish prior to assembly, the finish covers all areas which may otherwise be hard to reach after assembly, including intricate hidden areas at the door edge. The paint may applied in any color or may alternatively be applied to provide a textured wood grain effect finish. Combining the textured wood grain effect finish with the structural appearance of a traditional solid wood door provides a true likeness of a solid wood door without any of the disadvantages typically associated with solid wood doors. The texture wood grain effect is a result of the fusion of two materials, which are applied separately and subjected to high temperatures within a kiln. This process ensures a consistent thickness, texture and exceptionally hard and luxurious finish.

Each of the doors illustrated in FIGS. 9a-zd include the same frame described above. FIG. 9a shows a door 101 in which the panel includes three portions: a left portion including a vertical plank 6, a right portion including a vertical plank 6, and a centre portion including a plurality of horizontal planks 6. H-profiles 21 are provided between the adjacent portions.

FIG. 9b shows a door 102 in which the panel includes five portions each comprising a plurality of horizontal planks 6, with an H-profile 21 between the adjacent portions. FIG. 9c shows a door 103 in which the panel includes three portions: a lower portion comprising a plurality of vertical planks 6, an upper portion comprising a plurality of vertical planks, and a centre portion comprising a horizontal plank 6. H-profiles 21 are provided between the adjacent portions.

FIG. 9d shows a door 104 similar to FIG. 1. FIGS. 9e shows a door 105 in which the panel includes a plurality of portions each comprising horizontally or vertically arranged planks 6 with H-profiles 21 between the adjacent portions. FIG. 9f shows a door 106 similar to the door 103 but with a plurality of horizontal planks 6 in the centre portion.

FIG. 9g shows a door 107 similar to the door 104 but with a glass pane 25. An H-profile 21 is provided between the glass pane 25 and the planks 6 surrounding the edge of the glass pane. FIG. 9h shows a door 108 having a plurality of horizontal planks 6 and a plurality of glass panes 25 arranged similarly to the door 107. FIG. 9i shows a door 109 having a plurality of vertical planks 6 and a plurality of glass panes 25 arranged similarly to the door 107. FIG. 9j shows a door 110 similar to door 109 but with fewer, larger glass panes 25.

FIG. 9k shows a door 111 having a glass pane 25 arranged similarly to the door 110 and with detailing provided by H-profiles 21 surrounding a plurality of horizontal planks 6. FIG. 9l shows a door 112 similar to the door 103 but with additional detailing provided by H-profiles 21 either side of a plurality of vertical planks 6. FIGS. 9m and 9n show doors 113 and 114 respectively with upper and lower horizontal planks 65, 66 having surface stub detailing.

FIG. 9o shows a door 115 having a plurality of horizontal planks 6. FIG. 9p shows a door 116 similar to door 9a. FIG. 9q shows a door 117 having detailing provided by studded planks 65 and H-profiles 21. FIG. 9r shows a door 118 similar to door 105 with planks 6, 62 of different widths. FIG. 9s shows a door 119 with planks 6 arranged diagonally at an incline to the frame. FIG. 9t shows a door 120 with inclined and horizontal planks 6.

FIG. 9u shows a door 121 with inclined and horizontal planks 6 and an upper glass pane 25. FIG. 9v shows a door 122 with inclined and vertical planks 6 to form a herringbone pattern. FIGS. 9w, 9x and 9y show doors 123, 124, 125 respectively with combinations of inclined, horizontal and vertical planks 6. FIG. 9z shows a door 126 with inclined planks 6 and a triangular glass pane 25. FIG. 9za shows a door 127 with inclined and vertical planks 6.

FIGS. 9zb, 9zc and 9zd each show double doors 128, 129, 130 respectively comprising two discrete frames arranged with vertical symmetry.

FIG. 10 illustrates a door unit 200 comprising the door 1 of FIG. 1 installed in a doorway frame 26. The door 1 is mounted for movement with respect to a doorway frame 26, e.g. by hinges.

Although the invention has been described above with reference to one or more preferred embodiments, it will be appreciated that various changes or modifications may be made without departing from the scope of the invention as defined in the appended claims.

What is claimed is:

1. A door having a frame and panel construction, wherein the panel comprises a plurality of planks received in a rebate formed in the surrounding frame, and the planks include extruded aluminum profiles.

2. A door according to claim 1, wherein the planks interlock to form the panel.

3. A door according to claim 2, wherein the planks interlock using a tongue and groove system.

4. A door according to claim 2, wherein the planks interlock with an interference fit and without fasteners.

5. A door according to claim 1, wherein the planks are clipped together to form the panel.

6. A door according to claim 1, wherein the panel is received in the rebate in the frame with an interference fit.

7. A door according to claim 6, wherein the panel is secured in the rebate in the frame without fasteners and without exposed beading.

8. A door according to claim 1, wherein the planks are oriented horizontally, vertically, or at any intermediate angle.

9. A door according to claim 8, wherein the panel is divided into a plurality of plank portions each containing one or more of the planks, and at least one plank portion includes planks oriented differently to at least one other plank portion.

10. A door according to claim 9, wherein the panel includes a generally H-shaped profiled section interlocked between adjacent plank portions.

11. A door according to claim 1, wherein the panel further comprises a glass pane surrounded by the planks.

12. A door according to claim 11, wherein the panel includes a generally H-shaped profiled section interlocked between the glass pane and the surrounding planks.

13. A door according to claim 1, wherein each plank includes a pair of back-to-back extruded aluminum profiles with one or more thermally insulating bridges extending between the profiles.

14. A door according to claim 10, wherein the H-shaped profiled section includes a pair of back-to-back extruded aluminum profiles with a thermally insulating bridge extending between the profile.

15. A door according to claim 13, wherein the insulating bridge includes polyamide material.

16. A door according to claim 13, wherein the bridge is dovetailed to the aluminum profiles.

17. A door according to claim 1, wherein the frame includes extruded aluminum profiles.

18. A door according to claim 1, wherein the frame comprises rails and stiles.

19. A door according to claim 18, wherein the stiles and rails are mitred at each corner.

20. A door according to claim 1, wherein the planks and/or the frame are painted or anodised.

21. A door according to claim 20, wherein, when painted, the paint provides a textured wood grain effect finish.

22. A door unit comprising one or more doors according to claim 1 mounted for movement with respect to a doorway frame.

23. A method of assembling a door having a frame and panel construction, the method comprising assembling an incomplete frame having a rebate, assembling a panel by arranging a plurality of planks received in the rebate in the surrounding frame, and completing the frame after the panel assembly is complete, wherein the planks include extruded aluminum profiles.
